(19) United States
(12) Patent Application Publication
(10) Pub. No.: US 2025/0201099 A1
(43) Pub. Date: Jun. 19, 2025

(54) OBJECT DETECTION

(71) Applicant: Nokia Technologies Oy, Espoo (FI)

(72) Inventors: Utku Gunay ACER, Antwerp (BE); Marc VAN DEN BROECK, Antwerp (BE); Andrea FERLINI, Cambridge (GB)

(21) Appl. No.: 18/969,720

(22) Filed: Dec. 5, 2024

(30) Foreign Application Priority Data
Dec. 19, 2023 (GB) 2319511.8

(51) Int. Cl. G08B 21/18

(52) U.S. Cl. CPC G08B 21/18

(57) ABSTRACT

An apparatus, method and computer program is described comprising: obtaining movement type data from one or more of a set of one or more users, wherein the movement type data includes an indication of an object being put into a vehicle by one of said users and an indication of the object being removed from the vehicle by one of said users; and identifying a condition in which the object is in the vehicle and none of the set of one or more users is within the vehicle.

### FIELD

The present specification related to detecting objects in vehicles.

### BACKGROUND

Objects can easily be left in vehicles by users. One scenario is that multiple people are travelling in the vehicle, with each thinking that another person has taken a particular object out of the vehicle. Examples objects include a laptop, some other piece of equipment, or a child. Children being left in vehicles can lead to safety and health problems. For example, leaving a child (or an animal, such as a pet) in a vehicle in hot weather can lead to health problems and even death.

### SUMMARY

In a first aspect, this specification describes an apparatus comprising: means for obtaining movement type data from one or more of a set of one or more users (the set of one or more users may comprise a plurality of users), wherein the movement type data includes an indication of an object being put into a vehicle (e.g. a car) by one of said users and an indication of the object being removed from the vehicle by one of said users; and means for identifying a condition in which the object is in the vehicle and none of the set of one or more users is within the vehicle. The object may, for example, be a child. The apparatus may, for example, be a mobile communication device of one of the set of one or more users (e.g. one of a plurality of users).

Some example embodiments further comprise: means for determining whether the object is within the vehicle based, at least in part, on the movement type data. The means for identifying a condition may make use of the determination of whether the object is with the vehicle. Other data (such as imaging data from an imaging device such as a camera and/or audio data) may be used in said determination.

The apparatus may further comprise means for raising an alert regarding said condition. The alert may be raised following a delay period from identifying said condition. Alternatively, or in addition, the apparatus may further comprise means for informing one or more of said set of one or more users of said condition. The informing may occur following a delay period from identifying said condition.

Some example embodiments further comprise: means for obtaining sensor data, wherein said sensor data includes data obtained from a mobile communication device of a first user of said one or more users; and means for determining, using one or more models, movement type data relating to said first user based, at least in part, on the obtained sensor data. Sensor data for multiple users may be obtained and movement type data separately determined for some or all of the users.

At least one of said models may be for estimating a location of the first user's mobile communication device on said first user's body. In some example embodiments, a machine-learning model is used for estimating the location on said first user's body. Said one or more models for determining movement type data relating to the first user may identify movement type based, in part, on the estimated location of the first user's mobile communication device on said user's body. In some example embodiments, a machine-learning model is used for determining said movement type data.

The said sensor data may include at least one of: audio data (e.g. audio data captured within the vehicle); accelerometer data and gyroscope data.

Some example embodiments further comprise means for communicating the determined movement type data relating to said first user to some or all of said set of one or more users. Moreover, some example embodiments further comprise means for receiving identified movement type data relating to some or all of said set of one or more users.

Some example embodiments further comprise means for obtaining information relating to any user of the set of one or more users that is moving away from the vehicle. This information may be used when identifying the condition referred to above.

The set of users may comprise users travelling in the vehicle. Note that in some example embodiments, one or more of the set of users may not travel in the vehicle (e.g. a person may place the object within the vehicle but not travel in the vehicle).

Some example embodiments further comprise means for using location data (e.g. positioning data, such as global positioning system (GPS) data) of the mobile communication device of the first user to determine whether the vehicle is in motion. The movement type data may be obtained when said vehicle is not in motion. In some example embodiments, at least some data is not provided by a mobile communication device when the vehicle is determined to be in motion (thereby potentially saving battery power of the respective device(s)).

In a second aspect, this specification describes a method comprising: obtaining movement type data from one or more of a set of one or more users (the set of one or more users may comprise a plurality of users), wherein the movement type data includes an indication of an object (e.g. a child) being put into a vehicle (e.g. a car) by one of said users and an indication of the object being removed from the vehicle by one of said users; and identifying a condition in which the object is in the vehicle and none of the set of one or more users is within the vehicle.

The method may comprise raising an alert regarding said condition. The alert may be raised following a delay period from identifying said condition.

Alternatively, or in addition, the method may comprise informing one or more of said set of one or more users of said condition. The informing may occur following a delay period from identifying said condition.

The method may further comprise determining whether the object is within the vehicle based, at least in part, on the movement type data. Other data (such as imaging data from an imaging device such as a camera and/or audio data) may be used in said determination.

The method may comprise: obtaining sensor data (including data obtained from a mobile communication device of a first user of said one or more users); and determining, using one or more models (e.g. ML model(s)), movement type data relating to said first user based, at least in part, on the obtained sensor data. Sensor data for multiple users may be obtained and movement type data separately determined for some or all of the users. At least one of said models may be for estimating a location of the first user's mobile communication device on said first user's body. Said one or more models for determining movement type data relating to the first user may identify movement type based, in part, on the estimated location of the first user's mobile communication device on said user's body.

Some example embodiments further comprise communicating the determined movement type data relating to said first user to some or all of said set of one or more users. Moreover, some example embodiments further comprise receiving identified movement type data relating to some or all of said set of one or more users.

Some example embodiments further comprise obtaining information relating to any user of the set of one or more users that is moving away from the vehicle. This information may be used when identifying the condition referred to above.

Some example embodiments further comprise using location data (e.g. positioning data, such as global positioning system (GPS) data) of the mobile communication device of the first user to determine whether the vehicle is in motion. The movement type data may be obtained when said vehicle is not in motion.

In a third aspect, this specification describes computer-readable instructions which, when executed by a computing apparatus, cause the computing apparatus to perform (at least) any method as described herein (including the method of the second aspect described above).

In a fourth aspect, this specification describes a computer-readable medium (such as a non-transitory computer-readable medium) comprising program instructions stored thereon for performing (at least) any method as described herein (including the method of the second aspect described above).

In a fifth aspect, this specification describes an apparatus comprising: at least one processor; and at least one memory including computer program code which, when executed by the at least one processor, causes the apparatus to perform (at least) any method as described herein (including the method of the second aspect described above).

In a sixth aspect, this specification describes a computer program comprising instructions for causing an apparatus to perform at least the following: obtain movement type data from one or more of a set of one or more users, wherein the movement type data includes an indication of an object being put into a vehicle by one of said users and an indication of the object being removed from the vehicle by one of said users; and identify a condition in which the object is in the vehicle and none of the set of one or more users is within the vehicle.

In a seventh aspect, this specification describes an apparatus comprising an input (or some other means) for obtaining movement type data from one or more of a set of one or more users (the set of one or more users may comprise a plurality of users), wherein the movement type data includes an indication of an object being put into a vehicle (e.g. a car) by one of said users and an indication of the object being removed from the vehicle by one of said users; and a control module, processor or some other means for identifying a condition in which the object is in the vehicle and none of the set of one or more users is within the vehicle.

### BRIEF DESCRIPTION OF THE DRAWINGS

Example embodiments will now be described, by way of example only, with reference to the following schematic drawings, in which:

FIG. 1 is a flow chart showing an algorithm in accordance with an example embodiment;

FIGS. 2 to 4 are block diagrams of systems in accordance with example embodiments;

FIG. 5 is a flow chart showing an algorithm in accordance with an example embodiment;

FIG. 6 is a flow chart showing an algorithm in accordance with an example embodiment;

FIG. 7 is a block diagram of a system in accordance with an example embodiment;

FIGS. 8 to 10 are flow charts showing algorithms in accordance with example embodiments;

FIG. 11 is a block diagram of components of a system in accordance with an example embodiment; and

FIG. 12 shows an example of tangible media for storing computer-readable code which when run by a computer may perform methods according to example embodiments described above.

### DETAILED DESCRIPTION

The scope of protection sought for various embodiments of the disclosure is set out by the independent claims. The embodiments and features, if any, described in the specification that do not fall under the scope of the independent claims are to be interpreted as examples useful for understanding various embodiments of the disclosure.

In the description and drawings, like reference numerals refer to like elements throughout.

Children being left in vehicles can lead to safety and health problems. For example, leaving a child in a vehicle in hot weather can lead to health problems and even death. It should be noted that whilst many of the example embodiments relate to leaving a child in a vehicle, the principles described herein may be relevant to any object that may be left in a vehicle (such as a laptop or some other equipment). Note that as used herein, the term “object” covers anything (e.g. any object or entity) that can be loaded into, or removed from, a vehicle. Thus, the term “object” covers a person (such as a child), an animal (such as a pet), and additionally covers inanimate objects, such as a suitcase.

Some vehicles are equipped with systems to alert drivers to the presence of children in the vehicle. Such solutions may rely on specialized equipment in the vehicle, such as sensors, in-cabin cameras, etc. The requirement for such equipment tends to limit the penetration of such methods.

As discussed in detail below, some example embodiments describe the use of a model (such as a Human Activity Recognition (HAR) model) to detect when a person places an object (such as a child) into a vehicle and/or removes/picks up the object during a trip.

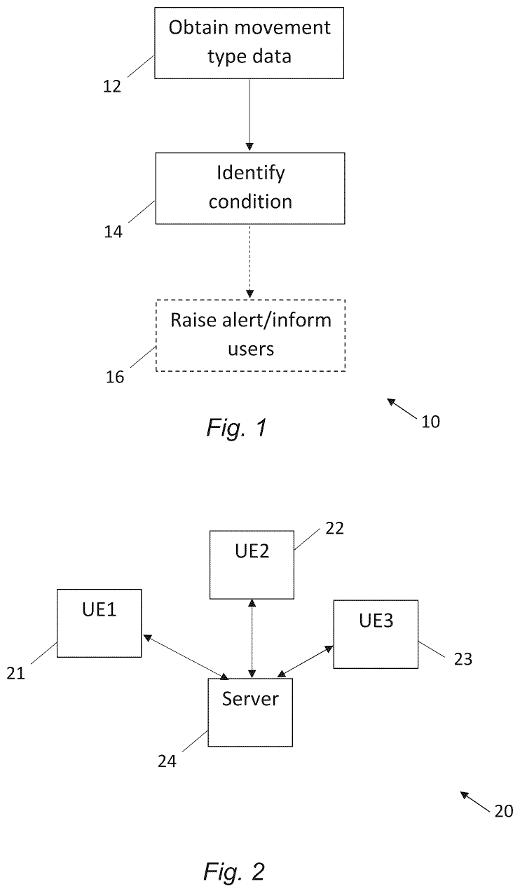

FIG. 1 is a flow chart showing an algorithm, indicated generally by the reference numeral 10, in accordance with an example embodiment. The algorithm 10 may, for example, be implemented (at least in part) using a mobile communication device (e.g. a mobile phone, user equipment, smartwatch or some other mobile communication device) of a user (e.g. one of the “set” of users discussed below). The mobile communication device, such as a user equipment (UE), may, for example, be a computing device typically carried by, worn by, or otherwise associated with a user such that the location of the mobile communication device (or UE) usually substantially corresponds to that of the user. Thus, within the sort of position accuracies that may be required by example embodiments described herein, the position of a mobile communication device (e.g. a UE) and the user of that device may be considered to be the same.

The algorithm 10 starts at operation 12, where movement type data is obtained from one or more of a set of one or more users. Note that the set of users may comprise a single user or a plurality of users. As discussed further below, the movement type data includes an indication of an object (e.g. a child) being put into a vehicle by one of said users and an indication of the object (e.g. the child) being removed from the vehicle by one of said users. The movement type data may include data collected by a mobile phone or similar device of the respective users (e.g. UEs of the respective users).

At operation 14, a condition is identified in which the object is in the vehicle and none of the set of one or more users is within the vehicle. The determination that the object is in the vehicle may be based, at least in part, on the movement type data obtained in the operation 12.

As indicated in the algorithm 10 (see operation 16), an action may be taken in response to identifying the condition in the operation 14. For example, an alert may be raised (e.g. following a delay period from identifying the condition). Alternatively, or in addition, one or more of the set of one or more users may be informed of the condition (again, this may be following a delay period). Thus, in some example embodiments, in the event that an object is erroneously left in the vehicle, an alert can be raised so that this can be corrected.

FIG. 2 is a block diagram of a system, indicated generally by the reference numeral 20, in accordance with an example embodiment. The system 20 may be used in an example implementation of the algorithm 10 described above.

The system 20 comprises a plurality of user equipments (UEs) that may be UEs of the set of users discussed above. In the example system 20, a first UE 21, a second UE 22 and a third UE 23 are shown (although any number of UEs may be provided, including a single UE). The system 20 further comprises a server 24 in two-way communication with the UEs 21 to 23. Note that although UEs are shown in the system 20 (and in other systems and methods described in detail below), the principles described herein are applicable if other user devices, as discussed above, are used.

The server 24 may receive movement type data from one or more (e.g. all) of the UEs 21 to 23, thereby obtaining the movement type data in an example implementation of the step 12 of the algorithm 20. In an alternative embodiment, the server 24 may receive sensor data from one or more of the UEs, with the server 24 determining the movement type data based on the sensor data (rather than the determination being made at the UE(s)).

The server 24 may then implement the operation 14 by identifying the condition in which the object is in the vehicle and none of the set of one or more users is within the vehicle.

The server 24 may implement the optional step 16 (e.g. by raising an alert and/or informing the users of the condition). For example, a message may be sent by the server 24 to each of the UEs 21 to 23 indicating that the condition has occurred. As noted above, the operation 16 may be implemented after a delay period since the identified of the condition; this may assist with avoiding false alerts.

Consider the following example in which the user of UE1 21 puts a child into a child seat of a vehicle. This action may be detected based on sensor data captured at the UE1 21 (e.g. from a pattern of accelerometer data). Some or all of the UEs 21 to 23 may be within the vehicle as the vehicle moves. (Note that the user of the UE 21 is not necessarily within the vehicle, since a user (e.g. a parent) may place a child in the vehicle without themselves travelling in the vehicle.) When the vehicle arrives at a destination, if all UEs that were within the vehicle then move away from the vehicle without UE sensor data from any of the UEs indicating that the child has been removed from the vehicle, then action can be taken in an instance of the operation 16 of the algorithm 10.

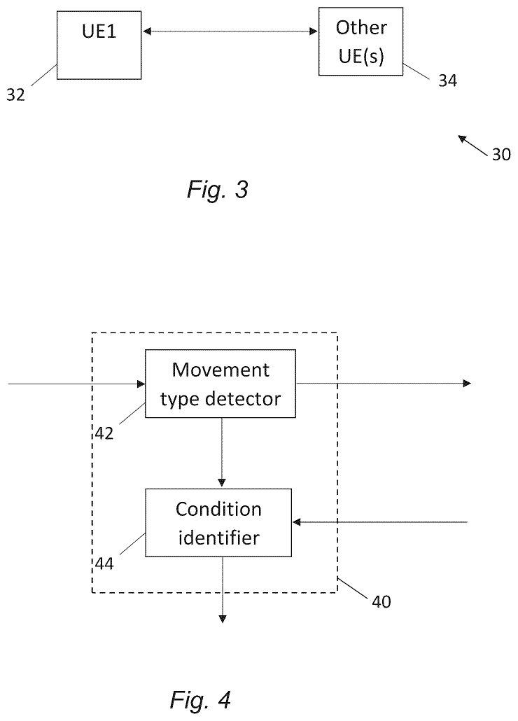

FIG. 3 is a block diagram of a system, indicated generally by the reference numeral 30, in accordance with an example embodiment. The system 30 may be used to implement the algorithm 10. As discussed further below, the system 30 differs from the system 20 in that a central server or processor is not required to implement the algorithm 10.

The system comprises a first user equipment (UE1) 32 and one or more other user equipments (UEs) 34. The UEs 32 and 34 belong to a plurality of users that form the set of users described above.

Consider the scenario described above in which the user of the first user equipment 32 puts a child into a child seat of a vehicle. This action may be detected based on sensor data captured at the first user equipment 32. Some or all of the UEs 32 and 34 may be within the vehicle as the vehicle moves (note again that the user of the UE 32 is not necessarily within the vehicle, since a user (e.g. a parent) may place a child in the vehicle without themselves travelling in the vehicle). When the vehicle arrives at a destination, if all UEs within that were the vehicle (e.g. the UEs 32 and 34) then move away from the vehicle without sensor data from any of the UEs indicating a movement type indicative of the child being removed from the vehicle, then action can be taken in an instance of the operation 16 of the algorithm 10. That action is triggered by one or more of the UEs 32, 34.

Thus, in the system 30, each step of the algorithm 10 is implemented at one or more of the UEs 32, 34.

Various mechanisms may be used in determining that a UE (or some other mobile communication device) that was within a vehicle and moved away from that vehicle. For example, the UE may determine that a user with which it is associated has walked in excess of a threshold distance (e.g. regardless of direction) and/or for longer than a threshold duration, either of which may indicate that the user has likely left the immediate vicinity of the vehicle. Alternatively, or in addition, the detection may be based upon sensing that a distance between the user and the vehicle (e.g. between the UE and the vehicle) has increased, for example by the UE determining that the strength of a signal emanating from the vehicle (for example a Bluetooth radio signal) has fallen below a threshold level, or by determining that the locations of the UE and the vehicle are different (e.g. based on positioning data). The skilled person will be aware of many further mechanisms that might be used for determining that a particular user has moved away from the vehicle.

FIG. 4 is a block diagram of a system, indicated generally by the reference numeral 40, in accordance with an example embodiment. The system 40 comprises a movement type detector 42 and a condition identifier 44. The system 40 may be implemented at one or more of the user equipments discussed above. Alternatively, or in addition, the system 40 may be implemented at the server 24. In an alternative embodiment, the functionality of the system 40 may be distributed (e.g. between different UEs or between one or more UEs and a server).

The movement type detector 42 receives sensor data (e.g. data from an inertial measurement unit (IMU) of a user equipment (UE) or some other mobile communication device). Based on the sensor data, the movement type detector 42 determines movement type data, such as an indication of an object (e.g. a child) being put into a vehicle by a user or an indication of the object being removed from the vehicle by a user. Thus, the movement type detector 42 can be used to implement the operation 12 of the algorithm 10 described above.

The movement type detector 42 provides details of the determined movement type data to the condition identifier 44 and may also provide details of the determined movement type data to other instances of the system 40 (for example to condition identifiers of instances of the system 40 implemented at other UEs).

The condition identifier 44 receives the details of the movement type data determined at the movement type detector 42 and optionally from other movement type detectors implemented at other instances of the system 40. The condition identifier 44 implements the operation 14 using the received movement type data. The condition identifier 44 provides an output (e.g. indicating whether or not a particular condition is identified).

In the event that the condition identifier 44 identifies from the movement type data that a particular object is in a vehicle and none of the set of one or more users is within the vehicle, then further action (such as raising an alert and/or informing users of the condition) can be taken based on the output of the condition identifier (as discussed above). Thus, the condition identifier may implement, or trigger, the operation 16 of the algorithm 10 described above.

Consider once again the scenario described above in which the user of a first user equipment (e.g. UE1 21 or UE1 32) puts a child into a child seat of a vehicle. This action may be detected by a movement type detector 42 of the respective user equipment (by a movement type detector 42 implemented elsewhere based on data obtained at the respective user equipment). When the vehicle arrives at a destination, if all UEs that were within the vehicle (e.g. the UEs 32 and 34) then move away from the vehicle without sensor data from any of the UEs indicating a movement type indicative of the child being removed from the vehicle, the movement of the users without the removal of the child from the vehicle may be identified by at least one instance of the condition identifier 44.

FIG. 5 is a flow chart showing an algorithm, indicated generally by the reference numeral 50, in accordance with an example embodiment. The algorithm 50 may be implemented by the movement type detector 42 of the system 40.

The algorithm 50 starts at operation 52, where sensor data is obtained (for example at an input of the movement type detector 42). The sensor data includes data obtained from a mobile communication device of a first user of the one or more users discussed above. Sensor data for multiple users could be obtained and movement data types for the multiple users separated determined.

The sensor data obtained in the operation 52 may take many forms. For example, the sensor data may include accelerator data and/or gyroscope data obtained from a mobile communication device of a user (e.g. a user equipment). Alternatively, or in addition, the sensor data may include audio data, such as audio captured within a vehicle; such audio data might, for example, relate to noises from a child (e.g. the sound of crying) that could assist with determining that a child is present.

In the operation 54, the movement type detector uses one or more models to determine movement type data relating to at least the first user. Some or all of the sensor data obtained in the operation 52 is provided to the model and the movement type data is based, at least in part, on said sensor data. As discussed further below, one or more machine learning (ML) model(s) may be used to implement the operation 54.

The movement type data determined in the operation 54 may be communicated to other users. For example, in the system 30, movement type data for the first user equipment 32 may be determined in the operation 54 and communicated to some or all of the other user equipments 34.

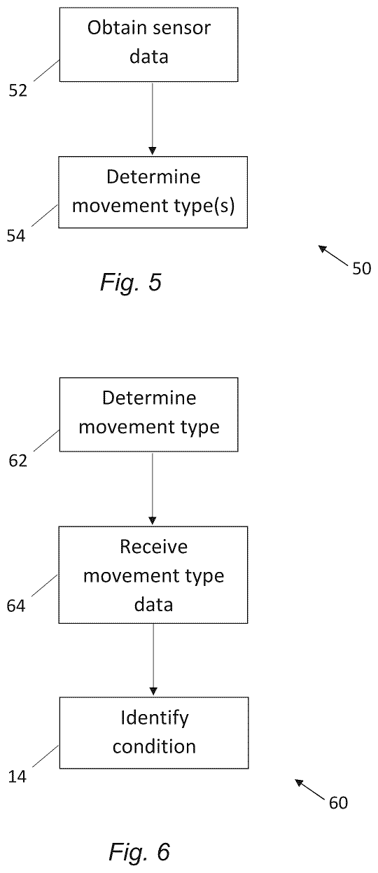

FIG. 6 is a flow chart showing an algorithm, indicated generally by the reference numeral 60, in accordance with an example embodiment. The algorithm 60 may be implemented by the system 40 described above.

The algorithm 60 starts at operation 62, where movement type data in relation to a first user is determined. The operation 62 may be implemented by the movement type detector 42 (as discussed above with reference to the algorithm 50, for example).

At operation 64, identified movement type data relating to one or more other users is received (for example at the condition identifier 44). Thus, the condition identifier 44 may receive both the movement type data determined in the operation 62 and similar data relating to one or more other users.

The determined and received movement type data can then be used to identify a condition (the operation 14 of the algorithm 10 described above).

As discussed above, the principles described herein may be implemented using the mobile communication devices (e.g. user equipments (UEs), smartphones or wearable devices) of users in the event that an object (such as a child) is left in a vehicle. These devices may be equipped with a host of sensors, such as an inertial measurement unit (IMU). The data from such sensors can be used for a wide range of applications that involve human activity recognition (HAR).

Using such techniques, data from mobile communication devices can be used to detect if the user is driving a vehicle or is a passenger in a vehicle, whether the user has placed an object (e.g. a child) in the vehicle and whether the user has removed the object from the vehicle when a trip is over.

The systems and algorithms described herein enable collaboration when multiple people are in a vehicle. As discussed above, communication can be enabled between mobile communication devices to understand whether an object (e.g. a child) has been placed in the vehicle by one user and picked up by a different user.

An example HAR pipeline involves pre-processing through some signal-processing functions to extract import features from the sensor data. An HAR application may also feed these features to a model (e.g. a machine learning model) to produce inferences about the use cases.

For example, data such as 3-axis accelerometer data and/or 3-axis gyroscope data can be obtained from an IMU. Accelerometer and gyroscope data may be respectively (and individually) passed through a low-pass filter to remove high frequency events that are not in scope with the movements described herein. The magnitude of each 3-axis signal may be computed and reduced to a single dimension (for example to seek to eliminate issues that may stem from the direction of the device). Moreover, instead of looking at the signal at one instance at time or over long periods of time, a sliding window may be used to localize the signal and have meaningful time-series.

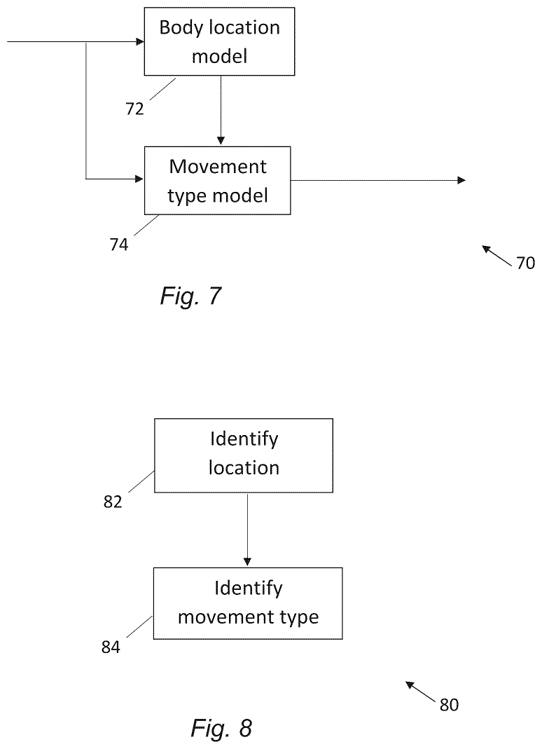

FIG. 7 is a block diagram of a system, indicated generally by the reference numeral 70, in accordance with an example embodiment. The system 70 comprises a body location model 72 and a movement type model 74. One or both of those models may be trained machine-learning models.

In an example embodiment, data obtained from a mobile communication device (e.g. accelerometer data and/or gyroscope data) is provided to both the body location model 72 and the movement type model 74. The body location model 72 detects a location of the mobile communication device on the respective user's body. This may be relevant since the location of the device may affect the signals from the IMU. The mobile communication device data and the output of the body location model 72 are both provided as inputs to the movement type model 74. The movement type model 74 detects user activity (for example identifying whether the user places an object (e.g. a child) in a vehicle or removes the object from the vehicle).

In order to further increase the accuracy of the modelling in the system 70, further data may be provided. For example, positioning information (such as GPS data) may be provided; such data may be useful for determining whether a vehicle is moving. In one example embodiment, some processes may only be carried out when a vehicle has stopped (which may result in power saving, which could be significant in the context of smartphone implementations).

As noted above, the body location model 72 and/or the movement type model 74 may be machine learning models. Such models may, for example, be trained using large datasets of corresponding use cases. The models may employ various machine learning techniques such as ML translation, personalization, etc.

FIG. 8 is a flow chart showing an algorithm, indicated generally by the reference numeral 80, in accordance with an example embodiment. The algorithm 80 may be implemented by the system 70 described above.

The algorithm 80 starts at operation 82, where a location of a first user's mobile communication device on the first user's body is determined. The operation 82 may be implemented by the model 72. Then, at operation 84, one or more movement types of the first user is/are identified based, in part, on the estimated location of the first user's mobile communication device on said user's body. The operation 84 may be implemented by the model 74.

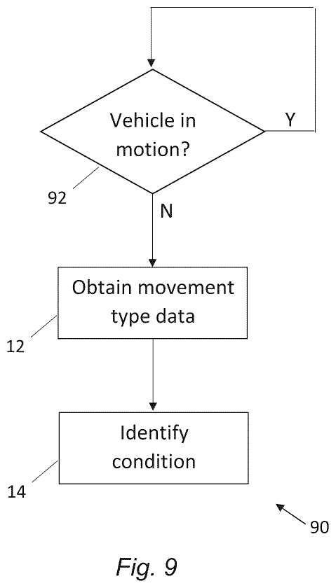

FIG. 9 is a flow chart showing an algorithm, indicated generally by the reference numeral 90, in accordance with an example embodiment.

The algorithm 90 starts at operation 92, where a determination is made regarding whether or not a particular vehicle is in motion. If so, the operation 92 is repeated until a determination is made that the vehicle is not in motion. As discussed above, location data of a mobile communication device (e.g. GPS data or other positioning data) may be used when determining whether the vehicle is in motion. In the step 92, sensor data (such as IMU data) may not be obtained from the respective user devices, which may reduce power consumption of mobile communication devices used to implement the algorithm 90.

The algorithm 90 then moves to the operation 12 described above, in which movement type data is obtained (when the vehicle is not in motion). The operation 12 may include obtaining information relating to any user of the set of one or more users that is moving away from the vehicle. The said set of users may comprise users travelling within a vehicle (however, as noted above, it is possible for users to perform actions, such as placing an object in the vehicle, or removing an object from the vehicle, without travelling in the vehicle).

The algorithm 90 then moves to the operation 14 described above in which a condition is identified.

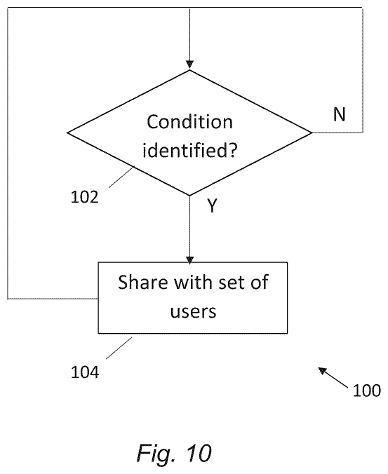

FIG. 10 is a flow chart showing an algorithm, indicated generally by the reference numeral 100, in accordance with an example embodiment.

The algorithm 102 starts at operation 102, where a determination is made regarding whether a condition is identified (e.g. by an instance of the operation 14 described above). If a condition is identified, the algorithm moves to operation 104, where details of the condition are shared with other users of the set of users (e.g. other users travelling in a vehicle). The algorithm 100 then returns to the operation 102. Note that the algorithm 100 may further comprise identifying the set of users.

For example, if a device detects the condition that a user has placed a child into the vehicle, this information may be shared with other users in the operation 104. Similarly, once a vehicle stops, if the removal of a child from the vehicle is detected in an instance of the operation 102, this information may be shared with the other users in an instance of the operation 104. If a user leaves the vehicle without picking up the child, this may also be shared with the other users in an instance of the operation 104. This process may be repeated each time one or more users leave the vehicle when the child (or some other object) is still there. An alert may then be raised when no users are remaining in the vehicle.

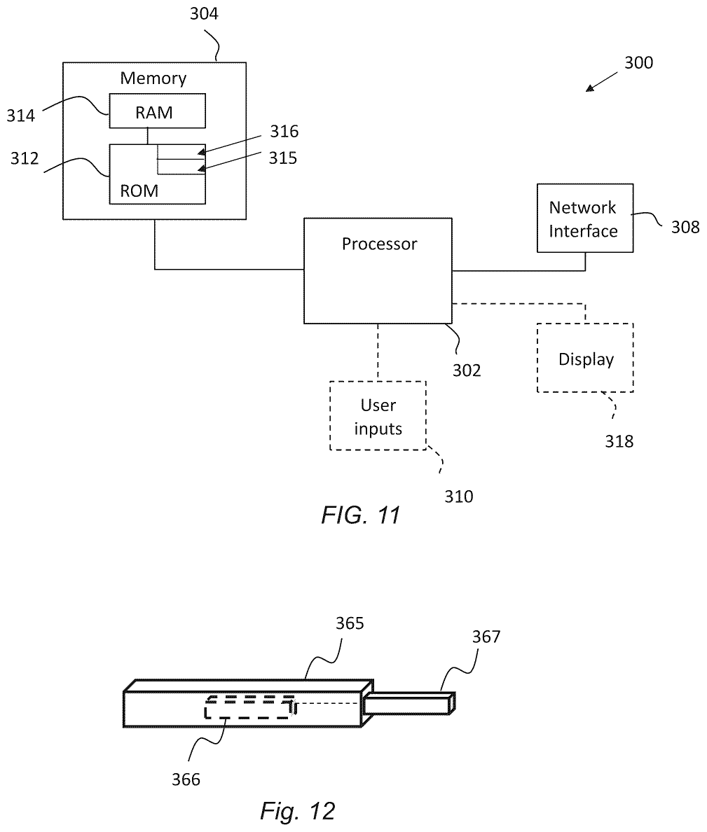

For completeness, FIG. 11 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 10, 50, 60, 80, 90 and 100 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 12 shows a tangible media, in the form of a removable memory unit 365, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. Of course, other forms of tangible storage media may be used, as will be readily apparent to those of ordinary skilled in the art. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 1, 5, 6 and 8 to 10 are examples only and that various operations depicted therein may be omitted, reordered and/or combined.

It will be appreciated that the above-described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1-21. (canceled)

22. An apparatus comprising:
at least one processor; and
at least one memory storing instructions that, when executed by the at least one processor, cause the apparatus at least to:
obtain movement type data from one or more of a set of one or more users, wherein the movement type data includes an indication of an object being put into a vehicle by one of said users and an indication of the object being removed from the vehicle by one of said users; and
identify a condition in which the object is in the vehicle and none of the set of one or more users is within the vehicle.

23. An apparatus as claimed in claim 22, wherein the instructions, when executed by the at least one processor, further cause the apparatus at least to:
determine whether the object is within the vehicle based, at least in part, on the movement type data.

24. An apparatus as claimed in claim 22, wherein the instructions, when executed by the at least one processor, further cause the apparatus at least to:
raise an alert regarding said condition.

25. An apparatus as claimed in claim 22, wherein the instructions, when executed by the at least one processor, further cause the apparatus at least to:
inform one or more of said set of one or more users of said condition.

26. An apparatus as claimed in claim 22, wherein the instructions, when executed by the at least one processor, further cause the apparatus at least to:
obtain sensor data, wherein said sensor data includes data obtained from a mobile communication device of a first user of said one or more users; and
determine, using one or more models, movement type data relating to said first user based, at least in part, on the obtained sensor data.

27. An apparatus as claimed in claim 26, wherein at least one of said models is for estimating a location of the first user's mobile communication device on said first user's body.

28. An apparatus as claimed in claim 27, wherein said one or more models for determining movement type data relating to the first user identifies movement type based, in part, on the estimated location of the first user's mobile communication device on said user's body.

29. An apparatus as claimed in claim 26, wherein said sensor data includes at least one of: audio data; accelerometer data or gyroscope data.

30. An apparatus as claimed in claim 26, wherein the instructions, when executed by the at least one processor, further cause the apparatus at least to:
communicate the determined movement type data relating to said first user to some or all of said set of one or more users.

31. An apparatus as claimed in claim 30, wherein the instructions, when executed by the at least one processor, further cause the apparatus at least to:
receive identified movement type data relating to some or all of said set of one or more users.

32. An apparatus as claimed in claim 22, wherein the instructions, when executed by the at least one processor, further cause the apparatus at least to:
obtain information relating to any user of the set of one or more users that is moving away from the vehicle.

33. An apparatus as claimed in claim 22, wherein said set of users comprises users travelling in the vehicle.

34. An apparatus as claimed in claim 22, wherein the instructions, when executed by the at least one processor, further cause the apparatus at least to:
use location data of the mobile communication device of the first user to determine whether the vehicle is in motion.

35. An apparatus as claimed in claim 34, wherein movement type data is obtained when said vehicle is not in motion.

36. An apparatus as claimed in claim 22, wherein said object is a child.

37. An apparatus as claimed in claim 22, wherein the apparatus is mobile communication device of one of the set of one or more users.

38. A method comprising:
obtaining movement type data from one or more of a set of one or more users, wherein the movement type data includes an indication of an object being put into a vehicle by one of said users and an indication of the object being removed from the vehicle by one of said users; and
identifying a condition in which the object is in the vehicle and none of the set of one or more users is within the vehicle.

39. A method as claimed in claim 38, further comprising raising an alert regarding said condition.

40. A method as claimed in claim 38, further comprising informing one or more of said set of one or more users of said condition.

41. A non-transitory computer-readable medium comprising program instructions which, when executed by an apparatus, cause the apparatus to perform at least the following:
obtaining movement type data from one or more of a set of one or more users, wherein the movement type data includes an indication of an object being put into a vehicle by one of said users and an indication of the object being removed from the vehicle by one of said users; and
identifying a condition in which the object is in the vehicle and none of the set of one or more users is within the vehicle.
